(19) United States
(12) Patent Application Publication
(10) Pub. No.: US 2026/0362193 A1
(43) Pub. Date: Nov. 12, 2026

(54) CARRIER MEASUREMENT METHOD AND APPARATUS, AND COMMUNICATION DEVICE

(71) Applicant: Beijing Xiaomi Mobile Software Co., Ltd., Beijing (CN)

(72) Inventor: Xuhua TAO, Beijing (CN)

(21) Appl. No.: 19/135,192

(22) PCT Filed: Dec. 14, 2022
(86) PCT No.: PCT/CN2022/138991

§ 371 Date: Jun. 3, 2025

(51) Int. Cl. H04W 24/10; H04L 27/26

(52) U.S. Cl. CPC H04W 24/10; H04L 27/2657

(57) ABSTRACT

The embodiments of the present disclosure relate to the technical field of mobile communications. Provided are a carrier measurement method and apparatus, and a communication device. The method comprises: when a timer expires, a user equipment (UE) executing a first measurement on an EMR carrier according to an EMR measurement extension factor, which is configured by a network device or agreed on by means of a protocol. Therefore, the validity and reliability of a necessary EMR measurement result can be maintained, thereby preventing the situation of the EMR measurement result being invalid or unreliable due to there being no EMR measurement for a long time.

### TECHNICAL FIELD

The present disclosure relates to the field of mobile communication technologies, and in particular, to a carrier measurement method and apparatus, and a communication device.

### BACKGROUND

In current New Radio (NR) protocols, EMR (Early Measurement Report) is introduced in order to support fast establishment of Dual-connectivity (DC) or carrier aggregation (CA) connection, that is, within a validity period of a timer T331, user equipment (UE) may perform measurement in an idle state or an inactive state according to configured carrier measurement information.

### SUMMARY

The present disclosure provides a carrier measurement method and apparatus, and a communication device. When a timer expires, EMR first measurement is introduced, which can maintain validity and reliability of necessary EMR measurement result, thereby avoiding invalid or unreliable EMR measurement result due to long-time absence of EMR measurement.

A first aspect of embodiments of the present disclosure provides a carrier measurement method, performed by a user equipment (UE), including: in response to determining that a timer expires, performing a first measurement on an early measurement report (EMR) carrier based on an EMR measurement extension factor configured by a network device or agreed in a protocol.

In some embodiments of the present disclosure, performing the first measurement on the EMR carrier based on the EMR measurement extension factor configured by the network device or agreed in the protocol includes: receiving carrier indication information configured by the network device, where the carrier indication information indicates related information of the EMR carrier for performing the first measurement; and performing the first measurement on the EMR carrier based on the carrier indication information.

In some embodiments of the present disclosure, the carrier indication information includes an identifier of an EMR carrier on which a second measurement has been performed, where the second measurement is an EMR measurement performed within a validity period of the timer, and performing the first measurement on the EMR carrier based on the carrier indication information includes: performing the first measurement on one or more EMR carriers corresponding to the identifier.

In some embodiments of the present disclosure, the carrier indication information includes carrier priority information, and performing the first measurement on the EMR carrier based on the carrier indication information includes: determining at least one EMR carrier on which a second measurement has been performed, where the second measurement is an ESR measurement performed within a validity period of the timer; determining, from the at least one EMR carrier, a carrier with measurement priority higher than or equal to the carrier priority information; and performing the first measurement on the carrier with the measurement priority higher than or equal to the carrier priority information.

In some embodiments of the present disclosure, the carrier indication information includes measurement threshold information, and performing the first measurement on the EMR carrier based on the carrier indication information includes: determining at least one EMR carrier on which a second measurement has been performed, where the second measurement is an ESR measurement performed within a validity period of the timer; determining, from the at least one EMR carrier, a carrier with a measurement result higher than or equal to the measurement threshold information; and performing the first measurement on the carrier with the measurement result higher than or equal to the measurement threshold information.

In some embodiments of the present disclosure, receiving the carrier indication information configured by the network device includes: receiving configuration signaling, where the configuration signaling includes the carrier indication information.

In some embodiments of the present disclosure, performing the measurement on the EMR carrier based on the EMR measurement extension factor configured by the network device or agreed in the protocol includes: determining a measurement interval according to the EMR measurement extension factor; and performing the measurement on the EMR carrier at the measurement interval.

In some embodiments of the present disclosure, the method further includes: receiving configuration signaling, where the configuration signaling includes the EMR measurement extension factor.

In some embodiments of the present disclosure, performing the first measurement on the EMR carrier based on the EMR measurement extension factor configured by the network device or agreed in the protocol includes: in response to determining that the timer expires and no random access initiation message is received, performing the first measurement on the EMR carrier based on the EMR measurement extension factor configured by the network device or agreed in the protocol.

A second aspect of embodiments of the present disclosure provides a carrier measurement method, performed by a network device, including: configuring an early measurement report (EMR) measurement extension factor, where the EMR measurement extension factor is used to assist a user equipment (UE) in performing a first measurement on an EMR carrier.

In some embodiments of the present disclosure, the method further includes: configuring carrier indication information, where the carrier indication information indicates related information of the EMR carrier for performing the first measurement by the UE.

In some embodiments of the present disclosure, the method further includes: sending configuration signaling to the UE, where the configuration signaling includes the EMR measurement extension factor, or the carrier indication information, or both.

A third aspect of embodiments of the present disclosure provides a carrier measurement apparatus, including a first measurement module, configured to: in response to determining that a timer expires, perform a first measurement on an early measurement report (EMR) carrier based on an EMR measurement extension factor configured by a network device or agreed in a protocol.

A fourth aspect of embodiments of the present disclosure provides a carrier measurement apparatus, including a configuration module, configured to: configure an early measurement report (EMR) measurement extension factor, where the EMR measurement extension factor is used to assist a user equipment (UE) in performing a first measurement on an EMR carrier.

A fifth aspect of embodiments of the present disclosure provides a communication device, including: a transceiver; a memory; and a processor, connected to the transceiver and the memory respectively, and configured to control wireless signal transmission and reception of the transceiver by executing a computer-executable instruction on the memory, to implement the method according to the embodiments of the first aspect or the embodiments of the second aspect of the present disclosure.

A sixth aspect of embodiments of the present disclosure provides a computer storage medium, where the computer storage medium stores a computer-executable instruction; and when the computer-executable instruction is executed by a processor, the method according to the embodiments of the first aspect or the second aspect of the present disclosure can be implemented.

A seventh aspect of embodiments of the present disclosure provides a communication system, including a user equipment (UE) and a network device, where the UE is configured to perform the method according to the embodiments of the first aspect of the present disclosure, and the network device is configured to perform the method according to the embodiments of the second aspect of the present disclosure.

According to the carrier measurement method of the present disclosure, in response to determining that a timer expires, a UE performs a first measurement on an early measurement report (EMR) carrier based on an EMR measurement extension factor configured by a network device or agreed in a protocol. The embodiments of the present disclosure provide a method for EMR measurement when a timer expires, which can maintain validity and reliability of necessary EMR measurement result, thereby avoiding invalid or unreliable EMR measurement result due to long-time absence of EMR measurement.

Some additional aspects and advantages of the present disclosure will be given in the following description, some will become apparent from the following description, or be learned through practice of the present disclosure.

### BRIEF DESCRIPTION OF DRAWINGS

The above aspects and other aspects and advantages of embodiments of the present disclosure will become apparent and more readily appreciated from the following descriptions made with reference to the drawings.

FIG. 1 is a schematic flowchart of a carrier measurement method according to an embodiment of the present disclosure.

FIG. 2 is a schematic flowchart of a carrier measurement method according to an embodiment of the present disclosure.

FIG. 3 is a schematic flowchart of a carrier measurement method according to an embodiment of the present disclosure.

FIG. 4 is a schematic diagram of a carrier measurement method according to an embodiment of the present disclosure.

FIG. 5 is a schematic flowchart of a carrier measurement method according to an embodiment of the present disclosure.

FIG. 6 is a schematic flowchart of a carrier measurement method according to an embodiment of the present disclosure.

FIG. 7 is a schematic diagram illustrating interactions in a carrier measurement method according to an embodiment of the present disclosure.

FIG. 8 is a schematic block diagram of a carrier measurement apparatus according to an embodiment of the present disclosure.

FIG. 9 is a schematic block diagram of a carrier measurement apparatus according to an embodiment of the present disclosure.

FIG. 10 is a schematic structural diagram of a communication device according to an embodiment of the present disclosure.

FIG. 11 is a schematic structural diagram of a chip according to an embodiment of the present disclosure.

### DETAILED DESCRIPTION

The embodiments of the present disclosure are described in detail below, and examples of the embodiments are shown in the accompanying drawings, where same or similar reference numerals represent same or similar elements or elements having same or similar functions throughout. The embodiments described below with reference to the accompanying drawings are examples and are intended to explain the present disclosure, and cannot be construed as limiting the present disclosure.

In current New Radio (NR) protocols, EMR (Early Measurement Report) is introduced in order to support fast establishment of Dual-connectivity (DC) or carrier aggregation (CA) connection, that is, within a validity period of a timer T331, user equipment (UE) may perform measurement in an idle state or an inactive state according to configured carrier measurement information, and when the UE reports the measurement result upon entering an active state, which could reduce latency of establishing DC or CA. The current measurement latency requirement is K_{carrier}*T_{detect,NR_Inter}, where K_{carrier} represents a number of EMR carriers configured to be measured, and T_{detect,NR_Inter} is shown in Table 1 below.

TABLE 1

| DRX | | | Tdetect, | Tmeasure, | Tevaluate, |
|---|---|---|---|---|---|
| Cycle | Scaling Factor | | NR_Inter [s] | NR_Inter [s] | NR_Inter [s] |
| Length | (N1) | | (number of | (number of | (number of |
| [s] | FR1 | FR2^{note} | DRX cycles) | DRX cycles) | DRX cycles) |
| 0.32 | 1 | 8 | 11.52 × | 1.28 × | 5.12 × |
| | | | N1 × 1.5 | N1 × 1.5 | N1 × 1.5 |
| | | | (36 × | (4 × | (16 × |
| | | | N1 × 1.5) | N1 × 1.5) | N1 × 1.5) |
| 0.64 | | 5 | 17.92 × N1 | 1.28 × N1 | 5.12 × |
| | | | (28 × N1) | (2 × N1) | N1(8 × N1) |
| 1.28 | | 4 | 32 × N1 | 1.28 × N1 | 6.4 × |
| | | | (25 × N1) | (1 × N1) | N1(5 × N1) |
| 2.56 | | 3 | 58.88 × N1 | 2.56 × N1 | 7.68 × |
| | | | (23 × N1) | (1 × N1) | N1(3 × N1) |

^{note}
Applies for UE supporting power class 2&3&4. For UE supporting power class 1 or 5, N1 = 8 for all DRX cycle length.

However, according to the requirements of the existing protocols, when the timer T331 expires, it is not specified in a standard on whether the UE needs to continue measuring the EMR carrier, if the UE receives a paging message for random access initiation long after the EMR measurement ended, as no EMR carrier measurement is performed for a long time, the EMR measurement result reported on Msg5 (which refers to RRCSetupComplete) may be invalid or unreliable.

To this end, the present disclosure provides a carrier measurement method and apparatus, and a communication device. When a timer expires, EMR first measurement is introduced, which can maintain validity and reliability of necessary EMR measurement result, thereby reducing or even avoiding possibility of invalid or unreliable EMR measurement result due to long-time absence of EMR measurement.

The solution provided by the present disclosure may be applied to a fifth generation (5G) mobile communication technology and subsequent communication technologies thereof, such as a 5G-advanced mobile communication technology, a sixth generation (6G) mobile communication technology, etc., which is not limited in the present disclosure.

The solutions provided by the present disclosure are described in detail below with reference to the accompanying drawings.

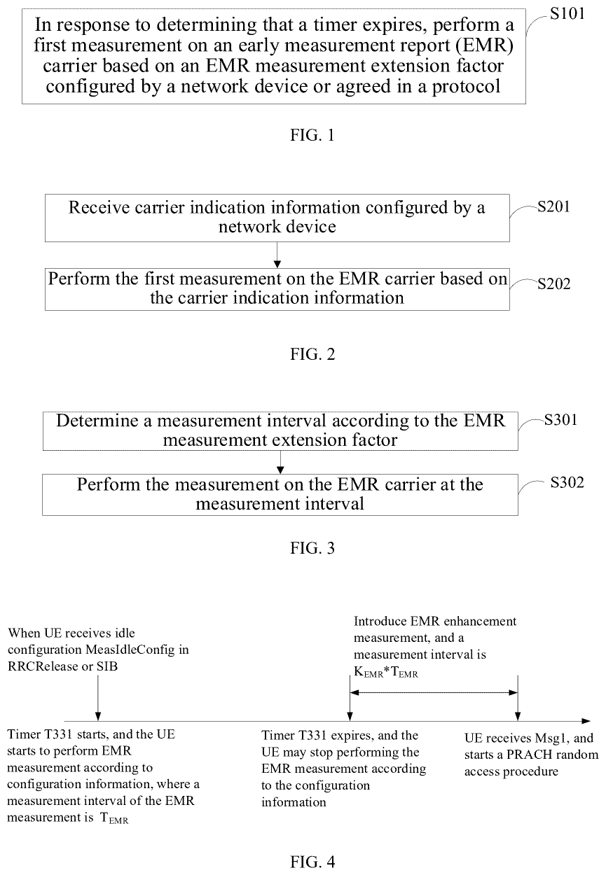

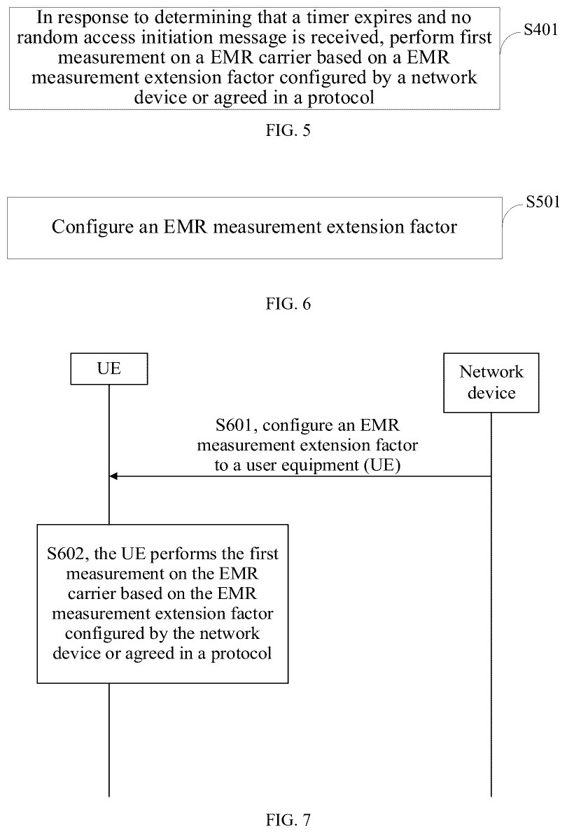

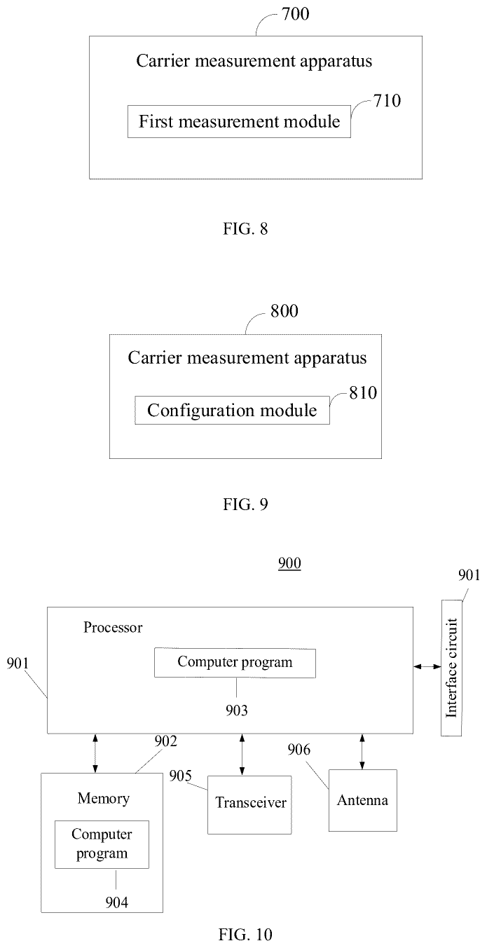

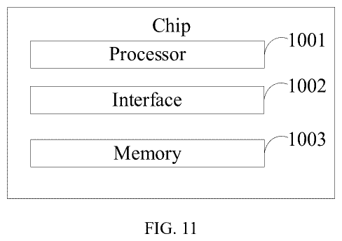

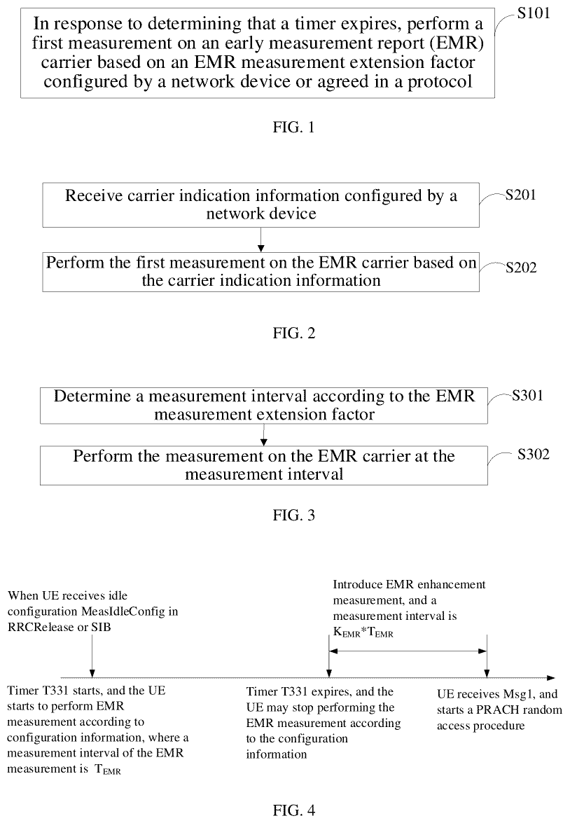

FIG. 1 is a schematic flowchart of a carrier measurement method according to an embodiment of the present disclosure. As shown in FIG. 1, the method is performed by a user equipment (UE). In the embodiments of the present disclosure, the user equipment (UE) includes, but is not limited to, an intelligent terminal device, a cellular phone, a wireless device, a handset, a mobile unit, a vehicle, an in-vehicle device, and the like, which is not limited in the present disclosure.

The method may include a following step.

S101, in response to determining that a timer expires, performing a first measurement on an early measurement report (EMR) carrier based on an EMR measurement extension factor configured by a network device or agreed in a protocol.

In an embodiment of the present disclosure, the network device includes, but is not limited to, a switch, a router, a bridge, a hub, a gateway, a network interface card (NIC), a wireless access point (WAP), a base station, etc., which is not limited in the present disclosure.

In an embodiment of the present disclosure, the first measurement refers to the EMR measurement performed on the EMR carrier after the timer T331 expires, and in the present disclosure, the first measurement may be referred to as an enhanced measurement, which is a pair of relative concepts with the EMR measurement performed within the validity period of the timer T331, which does not constitute a limitation to the present disclosure.

In an embodiment of the present disclosure, the timer may include a timer T331, which will not be repeated below.

The present disclosure may be applied to a case where an EMR measurement report is introduced in the NR protocol to quickly establish a DC or CA connection. In the NR protocol, the user equipment is in an idle state or an inactive state, and after the user equipment receives the RRCConnectionRelease or SIB (system information block) including measIdleConfig released by the network device, the timer T331 is started, and the UE starts to perform EMR measurement (referred to as second measurement in the present disclosure, that is, EMR measurement performed within the validity period of the timer T331), but in the case where the timer T331 expires, whether the UE needs to continue measuring the EMR carrier has not been standardized.

In an embodiment of the present disclosure, the case where the timer expires includes a moment when the timer expires and a duration after the timer expires. The present disclosure introduces an EMR enhancement measurement, so that the EMR enhancement measurement is performed in the case where the timer expires.

In an embodiment of the present disclosure, the EMR measurement extension factor is also referred to as an EMR enhancement measurement extension factor, which may be used to determine a measurement interval of the EMR enhancement measurement to assist the UE in performing the first measurement.

In an embodiment of the present disclosure, the UE may determine the measurement interval of the first EMR measurement according to the EMR measurement extension factor configured by the network device, and then perform the first measurement on the EMR carrier. For example, the network device may carry the EMR measurement extension factor in measIdleConfig, and send the measIdleConfig to the UE through a RRCConnectionRelease or a SIB, and the UE obtains the EMR measurement extension factor from the measIdleConfig.

Optionally, the UE may obtain a pre-agreed EMR measurement extension factor according to a protocol, and then perform the first measurement on the EMR carrier.

It can be understood that the present disclosure introduces the first EMR measurement in the case where the timer expires, and provides various ideas for the execution manner and process of the first EMR measurement.

According to the carrier measurement method of the present disclosure, in response to determining that a timer expires, a UE performs a first measurement on an early measurement report (EMR) carrier based on an EMR measurement extension factor configured by a network device or agreed in a protocol. The embodiments of the present disclosure provide a method for EMR measurement when a timer expires, which can maintain validity and reliability of necessary EMR measurement result, thereby avoiding invalid or unreliable EMR measurement result due to long-time absence of EMR measurement.

FIG. 2 is a schematic flowchart of a carrier measurement method according to another embodiment of the present disclosure. The method is performed by a user equipment (UE), and as shown in FIG. 2, the method may include following steps S201-S202.

S201, receiving carrier indication information configured by a network device.

The carrier indication information indicates related information of the EMR carrier for performing the first measurement.

In an embodiment of the present disclosure, the carrier indication information may be directly sent by the network device to the user equipment.

In the embodiment of the present disclosure, the UE may determine the EMR carrier for performing the first EMR measurement according to the carrier indication information configured by the network device, and then perform the first measurement on the EMR carrier, for example, the UE may acquire the carrier indication information according to the received RRCConnectionRelease or SIB including measIdleConfig released by the network device, the carrier indication information may be used to determine the EMR carrier for performing the first EMR measurement, and the UE performs the first EMR measurement on the indicated carrier, and the specific indication manner is not limited in the present disclosure.

In the present disclosure, the EMR carrier on which the first measurement is performed may be an NR carrier or an E-UTRAN carrier, where NR is short for New Radio, referred to as new wireless/new air interface, representing an access network of 5G, and E-UTRAN is short for Evolved UMTS (Universal Mobile Telecommunications System) Terrestrial Radio Access Network, referred to as Evolved UMTS Terrestrial Radio Access Network, representing an access network of 4G.

In an embodiment of the present disclosure, receiving the carrier indication information configured by the network device includes: receiving configuration signaling, where the configuration signaling includes the carrier indication information.

Further, the configuration signaling may include an IE (Information Element) MeasIdleConfig. The IE MeasIdleConfig may be configured or carried through an RRCRelease, or may be configured or carried through a SIB. Optionally, the carrier indication information may be carried through a field in the RRCRelease or the SIB, for example, carried through a MeasIdleConfig field in the RRCRelease or the SIB.

S202, performing the first measurement on the EMR carrier based on the carrier indication information.

For example, the user equipment performs, according to the carrier indication information configured by MeasIdleConfig, the first measurement on the indicated EMR carrier for the first measurement.

In the present disclosure, the carrier indication information may include an identifier, carrier priority information, measurement threshold information of the EMR carrier, or may also be any one or any combination thereof, which is not limited in the present disclosure.

In an optional embodiment of the present disclosure, the carrier indication information includes an identifier of an EMR carrier on which the second measurement has been performed, and the second measurement is an EMR measurement performed within a validity period of the timer. An embodiment of Step S202 includes: performing a first measurement on one or more EMR carriers corresponding to the identifier.

Specifically, the network device may configure, in the carrier indication information, an identifier of an EMR carrier on which the first measurement needs to be performed. In an optional embodiment, the network device may carry identifiers of all EMR carriers on which EMR measurement has been performed within the validity period of the timer T331 in the carrier indication information, or may carry identifiers of some EMR carriers on which EMR measurement has been performed within the validity period of the timer T331 in the carrier indication information. The UE may determine, based on the EMR carrier identifier in the carrier indication information, to perform the first measurement on one or more EMR carriers. In an optional embodiment, the UE may directly perform the first measurement on the EMR carriers corresponding to the identifiers carried in the carrier indication information. In another optional embodiment, the UE may select a part of EMR carriers indicated in the carrier indication information to perform the first measurement.

Therefore, according to the above embodiment, the UE may perform, according to the identifiers of the EMR carriers carried in the carrier indication information, the first measurement on one or more EMR carriers corresponding to the identifier, where the carriers corresponding to the identifiers are carriers on which the EMR measurement has been performed within the validity period of the timer T331. The embodiments of the present disclosure can maintain validity and reliability of necessary EMR measurement result, thereby reducing or even avoiding possibility of invalid or unreliable EMR measurement result due to long-time absence of EMR measurement.

In some optional embodiments of the present disclosure, the carrier indication information includes carrier priority information, and an embodiment of step S202 includes: determining at least one EMR carrier on which a second measurement has been performed a second measurement, where the second measurement is an ESR measurement performed within a validity period of the timer; determining, from the at least one EMR carrier, a carrier with measurement priority higher than or equal to the carrier priority information; and performing the first measurement on the carrier with the measurement priority higher than or equal to the carrier priority information.

The at least one EMR carrier on which the second measurement has been performed may include all or some EMR carriers on which the EMR measurement has been performed within the validity period of the timer T331, and details will not be repeated herein.

In an example of the present disclosure, the network device may add the carrier priority information to the IE MeasIdleConfig, and configure the carrier indication information of the first EMR measurement through the IE MeasIdleConfig, so that the carrier indication information includes the carrier priority information. For example, the carrier priority information includes a carrier priority P, so that the UE may determine an EMR carrier having a measurement priority higher than or equal to P in the at least one EMR carrier on which measurement is performed within the validity period of the timer, and perform the first measurement on the EMR carrier having the measurement priority higher than or equal to P.

Therefore, according to the above embodiment, the at least one EMR carrier on which the UE performs measurement within the validity period of the timer is determined; the carrier having measurement priority higher than or equal to the carrier priority information is determined from the at least one EMR carrier; and the first measurement is performed on the carrier having the measurement priority higher than or equal to the carrier priority information, so that validity and reliability of a necessary EMR measurement result can be maintained, thereby reducing or even avoiding a case in which an EMR measurement result is invalid or unreliable because of long-time absence of EMR measurement.

In some optional embodiments of the present disclosure, the carrier indication information includes measurement threshold information, and an embodiment of step S202 includes: determining at least one EMR carrier on which a second measurement has been performed by the UE, where the second measurement is an ESR measurement performed within a validity period of the timer; determining, from the at least one EMR carrier, a carrier with a measurement result higher than or equal to the measurement threshold information; and performing the first measurement on the carrier with the measurement result higher than or equal to the measurement threshold information. Specifically, the at least one EMR carrier is all of or part of EMR carriers on which the EMR measurement has been performed within the validity period of the timer T331, and details will not be repeated herein.

In an example of the present disclosure, the threshold information of the first measurement of the EMR carrier may be added to the IE MeasIdleConfig, and the threshold information of the first measurement of the EMR carrier may be configured through the IE MeasIdleConfig, and in this case, the carrier indication information includes the threshold information, so that a carrier having a measurement result higher than or equal to the measurement threshold information may be determined; and the first measurement is performed on the carrier having the measurement result higher than or equal to the measurement threshold information.

Therefore, according to the above embodiment, the at least one EMR carrier on which the UE performs measurement within the validity period of the timer is determined; the carrier having the measurement result higher than or equal to the measurement threshold information is determined from the at least one EMR carrier; and the first measurement is performed on the carrier having the measurement result higher than or equal to the measurement threshold information, which can maintain validity and reliability of a necessary EMR measurement result, thereby reducing or even avoiding a case in which an EMR measurement result is invalid or unreliable because of long-time absence of EMR measurement, and expanding a boundary of the first EMR measurement.

Based on the above, according to the carrier measurement method of the present disclosure performed by the UE, the UE receives the carrier indication information configured by the network device, where the carrier indication information indicates the related information of the EMR carrier for performing the first measurement, and performs the first measurement on the EMR carrier based on the carrier indication information, so that the validity and reliability of the necessary EMR measurement result can be maintained, thereby avoiding the case that the EMR measurement result is invalid or unreliable due to long-time absence of EMR measurement, and expanding the boundary of the first EMR measurement.

FIG. 3 is a schematic flowchart of a carrier measurement method according to an embodiment of the present disclosure. The method is performed by a user equipment (UE), and as shown in FIG. 3, the method may include following steps S301-S302.

For ease of understanding, FIG. 4 provides a schematic diagram of a carrier measurement method according to an embodiment of the present disclosure.

S301, determining a measurement interval according to the EMR measurement extension factor.

In some optional embodiments of the present disclosure, the method further includes: receiving configuration signaling, where the configuration signaling includes the EMR measurement extension factor.

The configuration signaling includes any one of an IE MeasIdleConfig, an RRCRelease, or a SIB. It should be understood that the configuration signaling may be an IE MeasIdleConfig, which may be transmitted or received through an RRCRelease or a SIB. Optionally, the EMR measurement expansion factor may be carried through a field in the RRCRelease or the SIB, for example, carried through a MeasIdleConfig field in the RRCRelease or the SIB.

It should be noted that the EMR measurement extension factor may also be obtained in agreement of a protocol, which is not limited in the present disclosure.

In the embodiment of the present disclosure, as shown in FIG. 4, the measurement interval refers to a measurement interval for performing the first EMR measurement, and the UE of the present disclosure may determine the measurement interval according to the EMR measurement extension factor.

In an example of the present disclosure, after the timer T331 expires, the measurement interval of the first EMR measurement may be determined by K_{EMR}*T_{EMR}, where K_{EMR} represents the EMR measurement extension factor, and T_{EMR} represents the measurement interval for performing EMR measurement.

S302, performing the measurement on the EMR carrier at the measurement interval.

For example, when the timer T331 expires, the user equipment performs measurement on the EMR carrier, and the user equipment may determine a corresponding measurement interval according to the measurement extension factor (K_{EMR}) and perform corresponding measurement.

Based on the above, according to the carrier measurement method of the present disclosure, the measurement interval is determined according to the EMR measurement extension factor; and the measurement is performed on the EMR carrier at the measurement interval, which can maintain the validity and reliability of the necessary EMR measurement result, and reduce or even avoid the situation that the EMR measurement result is invalid or unreliable due to long-time absence of EMR measurement.

FIG. 5 is a schematic flowchart of a carrier measurement method according to an embodiment of the present disclosure. The method is performed by a user equipment (UE), and as shown in FIG. 5, the method may include a following step.

Step 401, in response to determining that a timer expires and no random access initiation message is received, performing a first measurement on an EMR carrier based on an EMR measurement extension factor configured by a network device or agreed in a protocol.

In an embodiment of the present disclosure, a situation that the timer expires and no random access initiation message is received includes that the user equipment is in an idle state or an inactive state, and the timer expires, and no random access initiation message is received, for example no paging message or Msg1 message is received.

As shown in FIG. 4, a process that the user equipment performs the first EMR measurement may occur at a moment or after the timer T331 expires, and before the user equipment receives the transmission message Msg1 and starts a physical random access channel (PRACH) random access process.

In an embodiment of the present disclosure, the first measurement is performed on the EMR carrier according to the EMR measurement extension factor configured by the network device or agreed in the protocol, which may be specifically referred from the methods in the embodiments corresponding to FIG. 1, FIG. 2 and FIG. 3, which will not be repeated in the present disclosure.

Based on the above, according to the carrier measurement method of the present disclosure, in a case that the timer expires that no random access initiation message is received, a first measurement is performed on an EMR carrier according to an EMR measurement extension factor, which is configured by a network device or agreed in a protocol, which can maintain validity and reliability of a necessary EMR measurement result, thereby avoiding the situation of the EMR measurement result being invalid or unreliable due to long-time absence of EMR measurement.

It should be noted that all the different embodiments described above in the present disclosure may be implemented in any combination, and suitable implementation solutions may be selected according to specific application scenarios, which is not limited in the present disclosure.

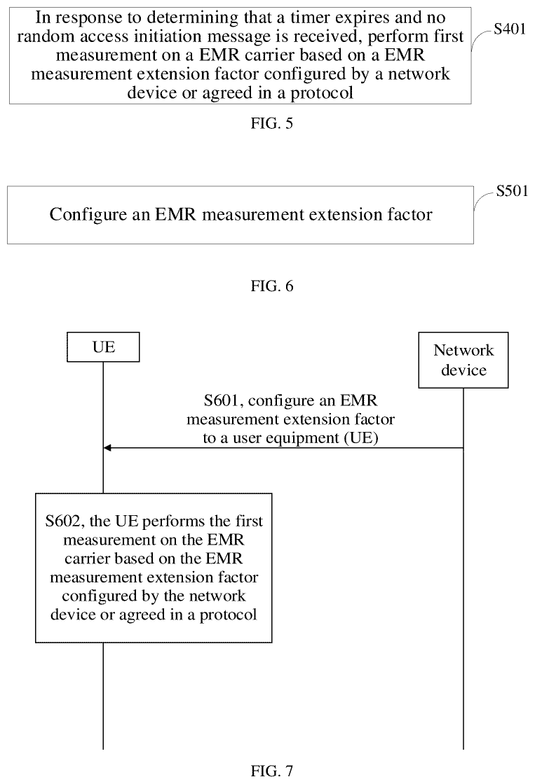

FIG. 6 is a schematic flowchart of a carrier measurement method according to an embodiment of the present disclosure. The method is performed by a network device, and as shown in FIG. 6, the method may include a following step. In an embodiment of the present disclosure, the network device includes, but is not limited to, a switch, a router, a bridge, a hub, a gateway, a network interface card (NIC), a wireless access point (WAP), a base station, etc., which is not limited in the present disclosure.

S501, configuring an EMR measurement extension factor.

The EMR measurement extension factor is used to assist a user equipment (UE) in performing a first measurement on an EMR carrier.

In the embodiments of the present disclosure, the UE includes, but is not limited to, an intelligent terminal device, a cellular phone, a wireless device, a handset, a mobile unit, a vehicle, an in-vehicle device, and the like, which is not limited in the present disclosure.

In an embodiment of the present disclosure, the EMR measurement extension factor may be used to determine the measurement interval of the first EMR measurement, for example, by K_{EMR}*T_{EMR}, where K_{EMR} represents the EMR measurement extension factor, and T_{EMR} represents the measurement interval for performing EMR measurement.

Further, the present disclosure focuses on a problem that in the NR protocol, whether the network device needs to continue measuring the EMR carrier after the timer T331 expires has not been standardized. Therefore, when the timer T331 expires, the first EMR measurement is introduced, the network device configures the user equipment (UE) with the EMR measurement extension factor, and the user equipment may perform the first measurement on the EMR carrier by using the EMR measurement extension factor.

In some optional embodiments of the present disclosure, the method further includes: configuring carrier indication information, where the carrier indication information indicates related information of the EMR carrier for performing the first measurement by the UE.

In an optional embodiment of the present disclosure, the network device may directly send the configured carrier indication information to the UE, and the UE may perform the first EMR measurement according to the carrier indication information configured by the network device.

Further, the carrier indication information indicates related information of the EMR carrier on which the UE performs the first measurement, and the related information of the EMR carrier includes at least one of: an identifier, carrier priority information, and measurement threshold information of the EMR carrier.

Further, the identifier of the EMR carrier is an identifier of a carrier on which EMR measurement has been performed within a validity period of a timer, and the UE may perform the first measurement on one or more EMR carriers corresponding to the identifier. The carrier priority information may be used to assist the UE in determining, from the at least one EMR carrier on which measurement is performed within the validity period of the timer, a carrier having measurement priority higher than or equal to the carrier priority information, and further perform the first measurement on the carrier having the measurement priority higher than or equal to the carrier priority information. The measurement threshold information may be used to assist the UE in determining, from the at least one EMR carrier on which measurement is performed within the validity period of the timer, a carrier having a measurement result higher than or equal to the measurement threshold information, and further perform the first measurement on the carrier having the measurement result higher than or equal to the measurement threshold information.

In some optional embodiments of the present disclosure, the method further includes: sending configuration signaling to the UE, where the configuration signaling includes the EMR measurement extension factor, or the carrier indication information, or both. The network device sends configuration signaling to the UE, where the configuration signaling includes any one of an IE MeasIdleConfig, an RRCRelease, or a SIB, and the configuration signaling may be used to carry an EMR measurement extension factor and/or carrier indication information.

In the embodiment of the present disclosure, the network device may configure the EMR measurement extension factor and/or the carrier indication information in the IE MeasIdleConfig, and carry the IE MeasIdleConfig in the RRCRelease or the SIB to transmit to the UE. Optionally, the network device may carry the EMR measurement extension factor and/or the carrier indication information in a field in the RRCRelease or the SIB, which is not limited in the present disclosure.

In the embodiment of the present disclosure, the network device configures the EMR measurement extension factor in the IE MeasIdleConfig, the RRCRelease or the SIB, and transmits the IE MeasIdleConfig, the RRCRelease or the SIB to the UE, so that the UE can acquire the EMR measurement extension factor to perform the first measurement; and the network device configures the carrier indication information in the IE MeasIdleConfig, the RRCRelease or the SIB, and transmits the IE MeasIdleConfig, the RRCRelease or the SIB to the UE, so that the UE can acquire the carrier indication information to perform the first measurement. The EMR measurement extension factor may be used to determine the measurement interval, the carrier indication information may be used to determine the EMR carrier for performing the first EMR measurement, and the network device may simultaneously or separately configure the EMR measurement extension factor and the carrier indication information through the above messages, which is not limited in the present disclosure.

Based on the above, according to the carrier measurement method of the present disclosure, the EMR measurement extension factor is configured by the network device, where the EMR measurement extension factor is used to assist the UE in performing the first measurement on the EMR carrier, and further assist the UE in performing the first EMR measurement, so that the validity and reliability of the necessary EMR measurement result can be maintained, and the situation that the EMR measurement result being invalid or unreliable due to long-time absence of EMR measurement is avoided.

FIG. 7 is a schematic diagram illustrating interactions in a carrier measurement method according to an embodiment of the present disclosure. As shown in FIG. 7, this embodiment relates to data/signaling interaction between a network device and a user equipment (UE) in a process of performing a positioning measurement method. Based on the embodiments shown in FIG. 1 to FIG. 6, the method includes following steps.

S601, a network device configures an EMR measurement extension factor.

The EMR measurement extension factor is used to assist a user equipment (UE) in performing a first measurement on an EMR carrier.

Optionally, step S601 further includes: the network device configures carrier indication information for the UE, where the carrier indication information indicates related information of an EMR carrier for performing a first measurement by a UE.

Optionally, step S601 further includes: the network device sends configuration signaling to the UE, where the configuration signaling includes the EMR measurement extension factor, or the carrier indication information, or both.

S602, the UE performs the first measurement on the EMR carrier based on the EMR measurement extension factor configured by the network device or agreed in a protocol.

Optionally, step S602 includes: the UE receives the carrier indication information configured by the network device, where the carrier indication information indicates related information of an EMR carrier for performing the first measurement; and the UE performs the first measurement on the EMR carrier based on the carrier indication information.

The carrier indication information includes an identifier of an EMR carrier on which a second measurement has been performed, where the second measurement is an EMR measurement performed within a validity period of the timer, and the embodiment of performing the first measurement on the EMR carrier based on the carrier indication information by the UE includes: performing the first measurement on one or more EMR carriers corresponding to the identifier.

When the carrier indication information includes carrier priority information, the embodiment of performing the first measurement on the EMR carrier based on the carrier indication information by the UE includes: determining at least one EMR carrier on which a second measurement has been performed, where the second measurement is an ESR measurement performed within a validity period of the timer; determining, from the at least one EMR carrier, a carrier with measurement priority higher than or equal to the carrier priority information; and performing the first measurement on the carrier with the measurement priority higher than or equal to the carrier priority information.

When the carrier indication information includes measurement threshold information, the embodiment of performing the first measurement on the EMR carrier based on the carrier indication information by the UE includes: determining at least one EMR carrier on which a second measurement has been performed, where the second measurement is an ESR measurement performed within a validity period of the timer; determining, from the at least one EMR carrier, a carrier with a measurement result higher than or equal to the measurement threshold information; and performing the first measurement on the carrier with the measurement result higher than or equal to the measurement threshold information.

It should be understood that the above three embodiments may be combined or simultaneously implemented, and the carrier indication information may carry at least one of the identifier of the EMR carrier on which the second measurement has been performed, the carrier priority information, or the measurement threshold information, which is not limited in the present disclosure. For example, the carrier indication information includes the identifier of the EMR carrier on which the second measurement has been performed and the carrier priority information, and the UE may determine, based on the carrier priority information, a carrier corresponding to an identifier that meets a condition, to perform the first measurement. For another example, the carrier indication information includes the carrier priority information and the measurement threshold information, and the UE may determine an EMR carrier that meets both the priority condition and the threshold condition to perform the first measurement. Other possible embodiments are all included in the scope of the present disclosure, which will not be described herein.

Optionally, step S602 further includes: the UE receives configuration signaling, where the configuration signaling includes the carrier indication information.

Optionally, step S602 further includes: the UE determines a measurement interval according to the EMR measurement extension factor; and performs measurement on the EMR carrier at the measurement interval.

Optionally, step S602 further includes: the UE receives configuration signaling, where the configuration signaling includes the EMR measurement extension factor.

Optionally, step S602 further includes: in response to determining that the timer expires and no random access initiation message is received, performing the first measurement on the EMR carrier based on the EMR measurement extension factor configured by the network device or agreed in the protocol.

It should be understood that the above step S601 is an optional step, and the EMR measurement extension factor may be specified in a protocol, and does not need to be configured by the network device for the UE.

The principle of the above steps S601-S602 is similar to that of the steps described in FIG. 1 to FIG. 6, and related description in FIG. 1 to FIG. 6 can be referred to, which will not be repeated herein.

Based on the above, according to the carrier measurement method provided by the embodiments of the present disclosure, when a timer expires, a user equipment (UE) may perform a first measurement on an EMR carrier according to an EMR measurement extension factor, which is configured by a network device or agreed in a protocol, which can maintain the validity and reliability of a necessary EMR measurement result, thereby avoiding the situation of the EMR measurement result being invalid or unreliable due to long-time absence of EMR measurement.

In the above embodiments provided in the present disclosure, the methods provided in the embodiments of the present disclosure are described separately from perspectives of the network device and the user equipment. To implement the functions in the method provided in the above embodiments of the present disclosure, the network device and the user equipment may include a hardware structure and a software module, and the above functions are implemented in a form of the hardware structure, the software module, or a combination of the hardware structure and the software module. A function in the above functions may be performed by using a hardware structure, a software module, or a combination of a hardware structure and a software module.

Corresponding to the carrier measurement method provided by the above several embodiments, the present disclosure further provides a carrier measurement apparatus, and as the carrier measurement apparatus provided in the embodiments of the present disclosure corresponds to the carrier measurement method provided in the above several embodiments, the implementation of the carrier measurement method is also applicable to the carrier measurement apparatus provided by the present embodiment, which will not be described in detail in this embodiment.

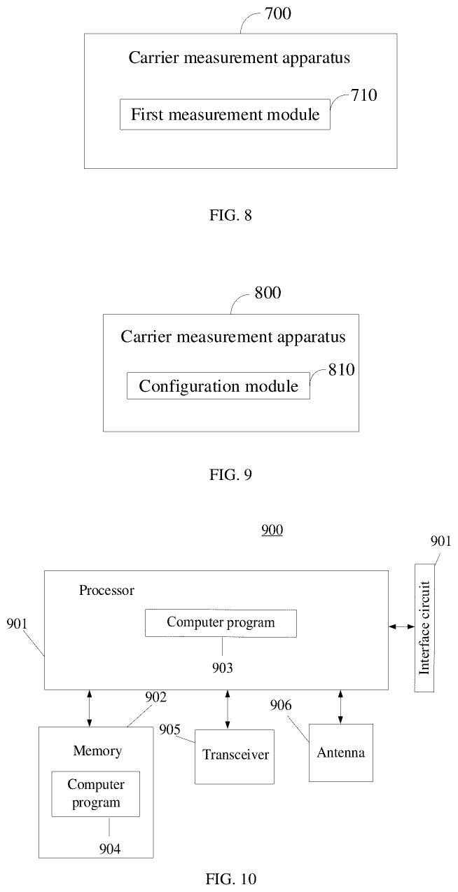

FIG. 8 is a schematic structural diagram of a carrier measurement apparatus 700 according to an embodiment of the present disclosure.

As shown in FIG. 8, the apparatus 700 may include: a first measurement module 710, configured to: in response to determining that a timer expires, perform a first measurement on an early measurement report (EMR) carrier based on an EMR measurement extension factor configured by a network device or agreed in a protocol.

According to the carrier measurement apparatus provided by the embodiments of the present disclosure, when a timer expires, a user equipment (UE) performs a first measurement on an EMR carrier according to an EMR measurement extension factor configured by a network device or agreed in a protocol, which can maintain the validity and reliability of a necessary EMR measurement result, thereby preventing the situation of the EMR measurement result being invalid or unreliable due to long-time absence of EMR measurement.

In some embodiments, the first measuring module 710 is configured to: receive the carrier indication information configured by the network device, where the carrier indication information indicates related information of an EMR carrier for performing the first measurement; and perform the first measurement on the EMR carrier based on the carrier indication information.

In some embodiments, the carrier indication information includes an identifier of an EMR carrier on which the second measurement has been performed, and the second measurement is an EMR measurement performed within a validity period of the timer. The first measurement module 710 is configured to: perform a first measurement on one or more EMR carriers corresponding to the identifier.

In some embodiments, the carrier indication information includes carrier priority information, and the first measurement module 710 is configured to: determine at least one EMR carrier on which a second measurement has been performed, where the second measurement is an ESR measurement performed within a validity period of the timer; determine, from the at least one EMR carrier, a carrier with measurement priority higher than or equal to the carrier priority information; and perform the first measurement on the carrier with the measurement priority higher than or equal to the carrier priority information.

In some embodiments, the carrier indication information includes measurement threshold information, and the first measurement module 710 is configured to: determine at least one EMR carrier on which a second measurement has been performed, where the second measurement is an ESR measurement performed within a validity period of the timer; determine, from the at least one EMR carrier, a carrier with a measurement result higher than or equal to the measurement threshold information; and perform the first measurement on the carrier with the measurement result higher than or equal to the measurement threshold information.

In some embodiments of the present disclosure, the first measurement module 710 is further configured to: receive configuration signaling, where the configuration signaling includes carrier indication information.

In some embodiments, the first measurement module 710 is further configured to: determine a measurement interval according to the EMR measurement extension factor; and performs measurement on the EMR carrier at the measurement interval.

In some embodiments, the first measurement module 710 is further configured to: receive configuration signaling, where the configuration signaling includes the EMR measurement extension factor.

Based on the above, according to the carrier measurement apparatus of the present disclosure, when a timer expires, a user equipment (UE) performs a first measurement on an EMR carrier according to an EMR measurement extension factor configured by a network device or agreed in a protocol, which can maintain the validity and reliability of a necessary EMR measurement result, thereby preventing the situation of the EMR measurement result being invalid or unreliable due to long-time absence of EMR measurement.

FIG. 9 is a schematic structural diagram of a carrier measurement apparatus 800 according to an embodiment of the present disclosure.

As shown in FIG. 9, the apparatus 800 may include: a configuration module 810, configured to configure an EMR measurement extension factor, where the EMR measurement extension factor is used to assist a UE in performing a first measurement on an EMR carrier.

According to the carrier measurement apparatus of the present disclosure, the EMR measurement extension factor is configured, where the EMR measurement extension factor is used to assist the UE in performing the first measurement on the EMR carrier, and in such way, when a timer expires, the UE can perform the first measurement on the EMR carrier according to the EMR measurement extension factor configured by the network device or agreed in a protocol, which can maintain the validity and reliability of a necessary EMR measurement result, thereby preventing the situation of the EMR measurement result being invalid or unreliable due to long-time absence of EMR measurement.

In some embodiments, the configuration module 810 is configured to: configure carrier indication information, where the carrier indication information indicates related information of the EMR carrier for performing the first measurement by the UE.

In some embodiments, the configuration module 810 is further configured to: send configuration signaling to the UE, where the configuration signaling includes the EMR measurement extension factor, or the carrier indication information, or both.

According to the carrier measurement apparatus of the present disclosure, the EMR measurement extension factor is configured, where the EMR measurement extension factor is used to assist the UE in performing the first measurement on the EMR carrier, in such way when a timer expires, the UE can perform the first measurement on the EMR carrier according to the EMR measurement extension factor configured by the network device or agreed in a protocol, which can maintain the validity and reliability of a necessary EMR measurement result, thereby preventing the situation of the EMR measurement result being invalid or unreliable due to long-time absence of EMR measurement.

The present disclosure further provides a communication system applied to a core network. The communication system may be a long term evolution (LTE) system, a 5th generation (5G) mobile communication system, a 5G new radio (NR) system, another future new mobile communication system, or the like.

The communication system includes a network device and user equipment (UE).

The UE is configured to perform the method according to any one of the embodiments shown in FIG. 1 to FIG. 5.

The network device is configured to perform the method according to the embodiment shown in FIG. 6.

According to the communication system provided by the embodiments of the present disclosure, when a timer expires, a user equipment (UE) can perform a first measurement on an EMR carrier according to an EMR measurement extension factor configured by a network device or agreed in a protocol, which can maintain the validity and reliability of a necessary EMR measurement result, thereby preventing the situation of the EMR measurement result being invalid or unreliable due to long-time absence of EMR measurement.

Referring to FIG. 10, FIG. 10 is a schematic structural diagram of a communication device 900 according to an embodiment of the present disclosure. The communication device 900 may be a network device or a user equipment, or may be a chip, a chip system, a processor that supports the network device in implementing the above method, or may be a chip, a chip system, a processor that supports the user equipment in implementing the above method. The device may be configured to implement the method described in the above method embodiments, and details can be referred from the descriptions in the above method embodiments.

The communication device 900 may include one or more processors 901. The processor 901 may include a general-purpose processor, a special-purpose processor, or the like. For example, the processor may be a baseband processor or a central processing unit. The baseband processor may be configured to process a communication protocol and communication data, and the central processing unit may be configured to control a communication device (for example, a base station, a baseband chip, a terminal device, a terminal device chip, a DU (distributed unit), or a CU (centralized unit)), execute a computer program, and process data of the computer program.

Optionally, the communication device 900 may further include one or more memories 902, on which a computer program 904 may be stored, and the processor 901 executes the computer program 904, so that the communication device 900 performs the method described in the above method embodiments. Optionally, the memory 902 may further store data. The communication device 900 and the memory 902 may be separately disposed, or may be integrated together.

Optionally, the communication device 900 may further include a transceiver 905 and an antenna 906. The transceiver 905 may be referred to as a transceiver unit, a transceiver machine, a transceiver circuit, or the like, and is configured to implement receiving and sending functions. The transceiver 905 may include a receiver and a transmitter, the receiver may be referred to as a receiver or a receiving circuit, and is configured to implement a receiving function, and the transmitter may be referred to as a transmitter or a sending circuit, and is configured to implement a sending function.

Optionally, the communication device 900 may further include one or more interface circuits 907. The interface circuit 907 is configured to receive a code instruction and transmit the code instruction to the processor 901. The processor 901 runs the code instructions, to enable the communication apparatus 900 to perform the methods described in the above method embodiments.

In an embodiment, the processor 901 may include a transceiver configured to implement receiving and sending functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data, or the transceiver circuit, the interface, or the interface circuit may be configured to transmit or transfer a signal.

In an embodiment, the processor 901 may store a computer program 903, and the computer program 903 runs on the processor 901, so that the communication apparatus 900 can perform the method described in the above method embodiments. The computer program 903 may be fixed in the processor 901, and in this case, the processor 901 may be implemented by hardware.

In an embodiment, the communication apparatus 900 may include a circuit, and the circuit may implement a sending, receiving, or communication function in the above method embodiments. The processor and the transceiver described in this disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may alternatively be manufactured by using various IC process technologies, for example, a complementary metal oxide semiconductor (CMOS), an N-type metal oxide semiconductor (nMetal-oxide-semiconductor, NMOS), a P-type metal oxide semiconductor (positive channel metal oxide semiconductor, PMOS), a bipolar junction transistor (bipolar junction transistor, BJT), a bipolar CMOS (BiCMOS), silicon germanium (SiGe), and gallium arsenide (GaAs).

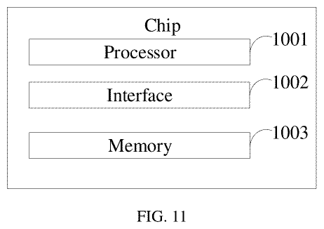

The communication device described in the above embodiments may be a network device or a user equipment, but the scope of the communication apparatus described in the present disclosure is not limited thereto, and the structure of the communication device may not be limited by FIG. 11. The communication device may be an independent device or may be a part of a larger device. For example, the communication device may be:
(1) an independent integrated circuit (IC), a chip, or a chip system or subsystem;
(2) a set of one or more ICs, where optionally, the IC set may further include a storage component configured to store data and a computer program;
(3) an ASIC (application specific integrated circuit), for example, a modem;
(4) a module that can be embedded within another device;
(5) a receiver, a terminal device, an intelligent terminal device, a cellular phone, a wireless device, a handheld phone, a mobile unit, a vehicle-mounted device, a network device, a cloud device, an artificial intelligence device, or the like;
(6) Other, etc.

For a case in which the communication device may be a chip or a chip system, refer to a schematic structural diagram of a chip shown in FIG. 11. The chip shown in FIG. 11 includes a processor 1001 and an interface 1002. There may be one or more processors 1001, and there may be a plurality of interfaces 1002.

Optionally, the chip further includes a memory 1003, and the memory 1003 is configured to store a necessary computer program and necessary data.

The present disclosure further provides a computer storage medium, the computer storage medium stores a computer-executable instruction, and when the computer-executable instruction is executed by a processor, functions of any one of the above method embodiments can be implemented.

Those skilled in the art may also understand that various illustrative logical blocks and steps listed in the embodiments of the present disclosure may be implemented by electronic hardware, computer software, or a combination thereof. Whether such functionality is implemented as hardware or software depends upon the particular application and design requirements of the overall system. A person skilled in the art may use various methods to implement functions for each particular application, but it should not be understood that the implementation goes beyond the protection scope of the embodiments of the present disclosure.

All or some of the above embodiments may be implemented by using software, hardware, firmware, or any combination thereof. When software is used to implement the embodiments, all or some of the embodiments may be implemented in a form of a computer program product. The computer program product includes one or more computer programs. When the computer programs are loaded and executed on a computer, the procedures or functions according to the embodiments of the present disclosure are all or partially generated. The computer may be a general-purpose computer, a special-purpose computer, a computer network, or another programmable apparatus. The computer program may be stored in a computer-readable storage medium or transmitted from one computer-readable storage medium to another computer-readable storage medium, for example, the computer program may be transmitted from one website, computer, server, or data center to another website, computer, server, or data center in a wired (for example, a coaxial cable, an optical fiber, or a digital subscriber line (DSL)) or wireless (for example, infrared, wireless, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a high-density digital video disc (DVD)), a semiconductor medium (for example, a solid-state drive (SSD)), or the like.

A person of ordinary skill in the art may understand that various numerical numbers such as first and second in the present disclosure are merely used for distinguishing for ease of description, and are not used to limit the scope of the embodiments of the present disclosure, and also represent a sequence.

At least one of the present disclosure may also be described as one or more, and the plurality may be two, three, four or more, which is not limited in the present disclosure. In the embodiments of the present disclosure, for a technical feature, the technical features in the technical feature are distinguished by “first”, “second”, “third”, “A”, “B”, “C”, and “D”, etc., and the technical features described by “first”, “second”, “third”, “A”, “B”, “C”, and “D” have no order or size sequence.

As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The systems and techniques described herein can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the systems and techniques described here), or any combination of such back end, middleware, or front end components. The components of the system can be interconnected by any form or medium of digital data communication, e.g., a communication network. Examples of communication networks include a local area network (LAN), a wide area network (WAN), and the Internet.

The computer system can include clients and servers. A client and server are generally remote from each other and typically interact through a communication network. The relationship of client and server arises by virtue of computer programs running on the respective computers and having a client-server relationship to each other.

It should be understood that various forms of the processes shown above may be used, with steps re-ordered, added, or deleted. For example, the steps described in the present disclosure may be performed in parallel, sequentially, or in a different order, as long as the desired result of the technical solution disclosed in the present disclosure can be achieved, which is not limited herein.

In addition, it should be understood that various embodiments of the present disclosure may be implemented separately or in combination with other embodiments as the solutions allow.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the above system, apparatus, and unit, refer to a corresponding process in the above method embodiments, and details are not described herein again.

What are described above is related to the illustrative embodiments of the disclosure only and not limitative to the scope of the disclosure; the scopes of the disclosure are defined by the accompanying claims. Therefore, the protection scope of the present disclosure should be subject to the protection scope of the claims.

1. A carrier measurement method, performed by a user equipment (UE), comprising:
in response to determining that a timer expires, performing a first measurement on an early measurement report (EMR) carrier based on an EMR measurement extension factor configured by a network device or agreed in a protocol.

2. The method according to claim 1, wherein performing the first measurement on the EMR carrier based on the EMR measurement extension factor configured by the network device or agreed in the protocol comprises:
receiving carrier indication information configured by the network device, wherein the carrier indication information indicates related information of the EMR carrier for performing the first measurement; and
performing the first measurement on the EMR carrier based on the carrier indication information.

3. The method according to claim 2, wherein the carrier indication information comprises an identifier of an EMR carrier on which a second measurement has been performed, wherein the second measurement is an EMR measurement performed within a validity period of the timer, and performing the first measurement on the EMR carrier based on the carrier indication information comprises:
performing the first measurement on one or more EMR carriers corresponding to the identifier.

4. The method according to claim 2, wherein the carrier indication information comprises carrier priority information, and performing the first measurement on the EMR carrier based on the carrier indication information comprises:
determining at least one EMR carrier on which a second measurement has been performed, wherein the second measurement is an EMR measurement performed within a validity period of the timer;
determining, from the at least one EMR carrier, a carrier with measurement priority higher than or equal to the carrier priority information; and
performing the first measurement on the carrier with the measurement priority higher than or equal to the carrier priority information.

5. The method according to claim 2, wherein the carrier indication information comprises measurement threshold information, and performing the first measurement on the EMR carrier based on the carrier indication information comprises:
determining at least one EMR carrier on which a second measurement has been performed, wherein the second measurement is an EMR measurement performed within a validity period of the timer;
determining, from the at least one EMR carrier, a carrier with a measurement result higher than or equal to the measurement threshold information; and
performing the first measurement on the carrier with the measurement result higher than or equal to the measurement threshold information.

6. The method according to claim 2, wherein receiving the carrier indication information configured by the network device comprises:
receiving configuration signaling, wherein the configuration signaling comprises the carrier indication information.

7. The method according to claim 1, wherein performing the first measurement on the EMR carrier based on the EMR measurement extension factor configured by the network device or agreed in the protocol comprises:
determining a measurement interval according to the EMR measurement extension factor; and
performing the first measurement on the EMR carrier at the measurement interval.

8. The method according to claim 1, further comprising:
receiving configuration signaling, wherein the configuration signaling comprises the EMR measurement extension factor.

9. The method according to claim 1, wherein performing the first measurement on the EMR carrier based on the EMR measurement extension factor configured by the network device or agreed in the protocol comprises:
in response to determining that the timer expires and no random access initiation message is received, performing the first measurement on the EMR carrier based on the EMR measurement extension factor configured by the network device or agreed in the protocol.

10. A carrier measurement method, performed by a network device, comprising:
configuring an early measurement report (EMR) measurement extension factor, wherein the EMR measurement extension factor is used to assist a user equipment (UE) in performing a first measurement on an EMR carrier.

11. The method according to claim 10, further comprising:
configuring carrier indication information, wherein the carrier indication information indicates related information of the EMR carrier for performing the first measurement by the UE.

12. The method according to claim 11, further comprising:
sending configuration signaling to the UE, wherein the configuration signaling comprises the EMR measurement extension factor, or the carrier indication information, or both.

13. (canceled)

14. (canceled)

15. A communication device, comprising:
a transceiver;
a memory; and
a processor, connected to the transceiver and the memory respectively, and configured to control wireless signal transmission and reception of the transceiver by executing a computer-executable instruction on the memory, to implement the method according to claim 1.

16. A non-transitory computer storage medium, wherein the computer storage medium stores a computer-executable instruction, and when the computer-executable instruction is executed by a processor, the processor is caused to implement the method according to claim 1.

17. A communication system, comprising:
a user equipment (UE); and
a network device,
wherein the UE is configured to; in response to determining that a timer expires, perform a first measurement on an early measurement report (EMR) carrier based on an EMR measurement extension factor configured by a network device or agreed in a protocol; and
the network device is configured to perform the method according to claim 10.
